(19) United States
(12) Patent Application Publication
(10) Pub. No.: US 2019/0199173 A1
(43) Pub. Date: Jun. 27, 2019

(54) ELECTRIC MOTOR FILLED WITH OIL

(71) Applicant: KSB SAS, Gennevilliers (FR)

(72) Inventors: Nicolas PETIT, Hazebrouck (FR); Anthony WATTEBLED, Attiches (FR); Alexandre BRISSON, Santes (FR)

(21) Appl. No.: 16/222,002

(22) Filed: Dec. 17, 2018

(30) Foreign Application Priority Data
Dec. 21, 2017 (FR) 17 71405

(51) Int. Cl. H02K 9/197; F04D 13/08; H02K 5/132; H02K 9/24

(52) U.S. Cl. CPC H02K 9/197; H02K 9/24; H02K 5/132; F04D 13/086

(57) ABSTRACT

The invention relates to an electric motor with an oil-tight frame enclosing a stator and a rotor and containing an electrically insulating oil that is a good conductor of heat. The oil is confined in almost all the space in the frame left free by the stator and the rotor.

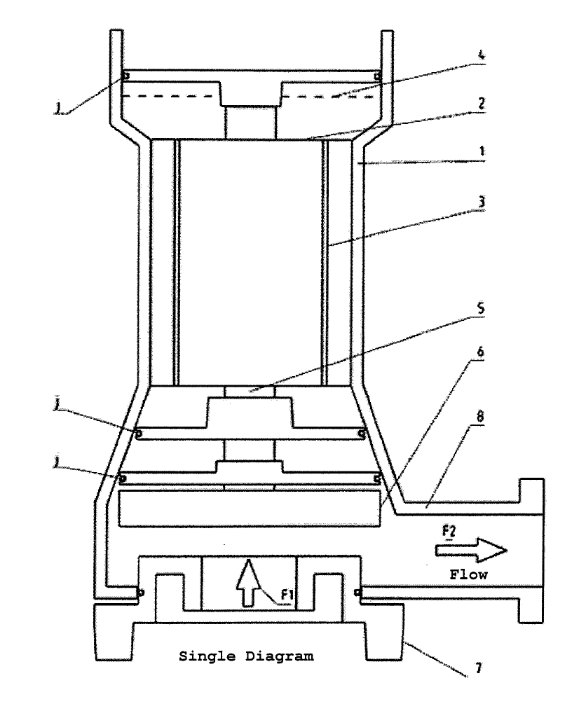

The present invention refers to electric motors and applies in particular to motor-pump units, comprising an impeller connected rigidly in rotation to the output shaft of an electric motor. The motor has an oil-tight frame enclosing a stator and a rotating rotor.

When the motor overheats, for example when the motor-pump unit is no longer submerged, the pump stops.

The invention overcomes this problem by means of a motor which can operate for longer and of which, surprisingly, the electrical efficiency is improved.

The subject of the invention is an electric motor, with an oil-tight frame enclosing a stator and a rotor and containing electrical insulating oil which is also a good conductor of heat, characterised in that the oil is confined in almost all the free space left in the frame by the stator and the rotor.

The invention also envisages a procedure for delaying the heating of the motor and/or increasing the electrical efficiency, characterised in that the oil is confined in the space in the frame left free by the rotor and the stator.

For preference from 60% to 100% and in particular from 90% to 100% or 99% of the volume of the space not occupied by the stator and the rotor in the frame is filled.

The oil is confined and is not transmitted outside the motor by a recirculation system. The motor is simple to use, since it is not necessary to check the oil level.

Since the oil is a good conductor of heat, the motor heats up less quickly and can operate for longer even if it is not submerged but, against all expectations, and despite the discounted effects of friction of the moving parts of the motor in the oil, the electrical efficiency of the motor is improved. The efficiency of the motor means the power available at the shaft in relation to the electrical power consumed.

The thermal conductivity of the oil at 25° C. may in particular be greater than or equal to 0.12 W/m.K and its dielectric strength greater than or equal to 27 kV.

For preference, a biodegradable oil is used which provides protection in the event of any leaks.

As an example of an oil of this type, isovoltine bio oil could be mentioned which can be obtained from Total and is based on high performance synthetic esters. The thermal conductivity of isovoltine at 25° C. is 0.14 W/m.K. Its dielectric strength is greater than 70 kV. This oil is particularly suitable because it is compatible with the bearings and bearing seals of the motor, while, for example, a silicone oil would give, as lubricant oil, a non-homogeneous mixture, which would adversely affect the operation of the pump. MIDEL oil 7131 based on synthetic esters is also particularly suitable. The thermal conductivity of MIDEL at 25° C. is 0.147 W/m.K. The dielectric strength is greater than 30 kV. HAFA Dielecs oil could also be used.

In the attached drawing, given only as an example, the single diagram shows an axial cross-sectional view of a motor-pump unit according to the invention.

The motor-pump unit comprises a frame 1 of an electric motor with a stator 3 and a rotor 2. The frame 1, including the space between the rotor 2 and the stator 3 is filled with oil up to the top level 4 indicated by a dotted line. The output shaft 5 of the rotating rotor drives an impeller 6, which draws in the fluid to be pumped through an inlet cover 7 according to the arrow F1 and discharges it through a flow pipe 8 according to the arrow F2. The various seals are marked j.

The frame of the motor of an Amarex NF 80-220/044 motor-pump unit was filled with oil (which can be obtained from the Applicant), the motor having a frame diameter of 135 millimetres and an impeller diameter of 195 millimetres, the motor having four poles rotating at 1,450 revolutions per minute. By filling the frame of a pump with a capacity of 20 m³ per hour with 2.75 litres of HAFA Dielecs electrically insulating oil which is a good conductor of heat, the electrical efficiency of the motor at nominal power increases from 68.4% to 69.8%.

What is claimed is:

1. An electric motor, with an oil-tight frame, enclosing a stator and a rotor and containing an electrically insulating oil which is a good conductor of heat, characterised in that the oil is confined in almost all the space left free by the stator and the rotor in the frame.

2. An electric motor according to claim 1, characterised in that the oil is biodegradable.

3. An electric motor according to claim 1, characterised in that the oil is ester-based.

4. An electric motor according to claim 1, characterised in that the dielectric strength of the oil is greater than or equal to 27 kV.

5. An electric motor according to claim 1, characterised in that the thermal conductivity of the oil at 25° is greater than or equal to 0.12 w/m.K.

6. A procedure for delaying the heating of an electric motor and for increasing its electrical efficiency, characterised in that the space in the frame left free by the rotor and the stator is filled with oil.

7. A procedure according to claim 6, characterised in that from 60 to 100% of the volume of the space left free is filled.

8. A procedure according to claim 7, characterised in that from 90 to 99% of the volume of the space left free is filled.

9. A motor-pump unit comprising an impeller connected rigidly in rotation to the output shaft (5) of an electric motor, the motor having an oil-tight frame enclosing a stator and a rotor and containing electrically insulating oil that is a good conductor of heat, characterised in that the oil is confined in almost all the space in the frame left free by the stator and the rotor.
